(19) United States
(12) Patent Application Publication
(10) Pub. No.: US 2006/0064336 A1
(43) Pub. Date: Mar. 23, 2006

(54) Method an system for facilitating electronic outsourcing value assessment

(76) Inventors: Reinaldo Miguel Cereseto, Weston, FL (US); Jae Hyun Kim, Weston, FL (US); Hector Giovanni Cano Ramos, Miami, FL (US); Alberto Elias Chacin Brito, Miami, FL (US)

Correspondence Address: ORACLE INTERNATIONAL CORPORATION;c/o A. RICHARD PARK, 2820 FIFTH STREET, DAVIS, CA, 95616-2914, US

(21) Appl. No.: 11/118,015

(22) Filed: Apr. 29, 2005

Related U.S. Application Data
(60) Provisional application No. 60/612,192, filed on Sep. 21, 2004.

(51) Int. Cl. G06F 17/50

(52) U.S. Cl. 705/7

(57) ABSTRACT

One embodiment of the present invention provides a system that facilitates performing a value assessment of electronic outsourcing of information technology. The system operates by first conducting marketplace research to determine an industry that would benefit from electronic outsourcing of information technology. Next, the system qualifies a prospect within the industry and researches the industry and the prospect to determine a current information technology capability of the prospect. The system then generates a value proposition for the Chief Executive Officer (CEO) of the prospect that identifies benefits of electronic outsourcing of information technology. This value proposition is presented to the CEO and the CEO's approval is obtained to conduct a workshop associated with electronic outsourcing of information technology to one or more highest-level executives of the prospect.

### RELATED APPLICATION

This application hereby claims priority under 35 U.S.C. §119 to U.S. Provisional Patent Application No. 60/612,192, filed on 21 Sep. 2004, entitled “Method and System for Facilitating Electronic Outsourcing Value Assessment,” by inventors Reinaldo Miguel Cereseto, Jai Hyun Kim, Hector Giovanni Cano Ramos, and Alberto Elias Chacin Brito. (Attorney Docket Number OR03-05901PSP).

### BACKGROUND

1. Field of the Invention

The present invention relates to methodologies for selling information technology. More specifically, the present invention relates to a method and a system that facilitates electronic outsourcing value assessment for information technology.

2. Related Art

Information technology is at the core of most modern businesses. In order to maintain a competitive advantage in the marketplace, it is essential for a business to continually invest in its information technology infrastructure to at least match (and hopefully exceed) the capabilities of its competitors. Investment decisions for information technology are particularly difficult, because changes in the underlying technology are both swift and unpredictable. Moreover, not having the latest capabilities can adversely affect the profitability of a business and can allow competitors to gain an advantage.

Since information technology is continually changing, it is difficult for a business to know which solutions will work best for a given situation. Furthermore, upgrading to a better solution typically requires a considerable commitment of time, manpower, and financial resources.

Many businesses outsource critical components of their information technology infrastructure to Application Service Providers (ASPs). While outsourcing information technology solutions to ASPs provides benefits in many situations, these outsourced solutions are typically expensive, are typically designed to accommodate many different business situations, and often do not fit specific business situations very well. Moreover, the process of upgrading these outsourced solutions can be as expensive, time-consuming, and manpower-intensive as upgrading in-house information technology solutions.

It is very hard for an executive to determine if a new technology solution makes sense. This makes it hard to sell technology solutions. Furthermore, even if an executive recognizes the need for a new technology solution, an executive is often confronted with problems in implementing a change due to: (1) low quality of infrastructure for facilitating change; and (2) insufficient urgency for change at all levels in the organization (even though change is occurring rapidly the in marketplace).

Hence, what is needed is a method and a system that facilitates assessing the value provided by a new technology solution.

### SUMMARY

One embodiment of the present invention provides a system that facilitates performing a value assessment of electronic outsourcing of information technology. The system operates by first conducting marketplace research to determine an industry that would benefit from electronic outsourcing of information technology. Next, the system qualifies a prospect within the industry and researches the industry and the prospect to determine a current information technology capability of the prospect. The system then generates a value proposition for the Chief Executive Officer (CEO) of the prospect that identifies benefits of electronic outsourcing of information technology. This value proposition is presented to the CEO and the CEO's approval is obtained to conduct a workshop associated with electronic outsourcing of information technology to one or more highest-level executives of the prospect.

In a variation of this embodiment, the highest-level executives of the prospect can include the CEO, a Chief Operating Officer (COO), a Chief Financial Officer (CFO), a Chief Information Officer (CIO), and other officers designated by the CEO.

In a further variation, conducting the workshop to the one or more highest-level executives of the prospect involves: estimating a value of outsourcing the information technology capability; estimating an investment required to implement outsourcing of the information technology capability; and producing an architecture and blueprint for outsourcing the information technology capability as applied to the prospect.

In a further variation, the system identifies and assesses prospective partners for facilitating outsourcing of the information technology capability.

In a further variation, the system selects partners, if necessary, for facilitating outsourcing of the information technology capability.

In a further variation, outsourcing of the information technology capability is demonstrated to the one or more highest-level executives of the prospect and additional persons designated by the CEO.

In a further variation, the system implements outsourcing of the information technology capability.

### BRIEF DESCRIPTION OF THE FIGURES

FIG. 1 illustrates benefits of electronic outsourcing of information technology in accordance with an embodiment of the present invention.

FIG. 2 presents a flowchart illustrating the process of implementing an electronic outsourcing solution to information technology in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Benefits of Electronic Outsourcing

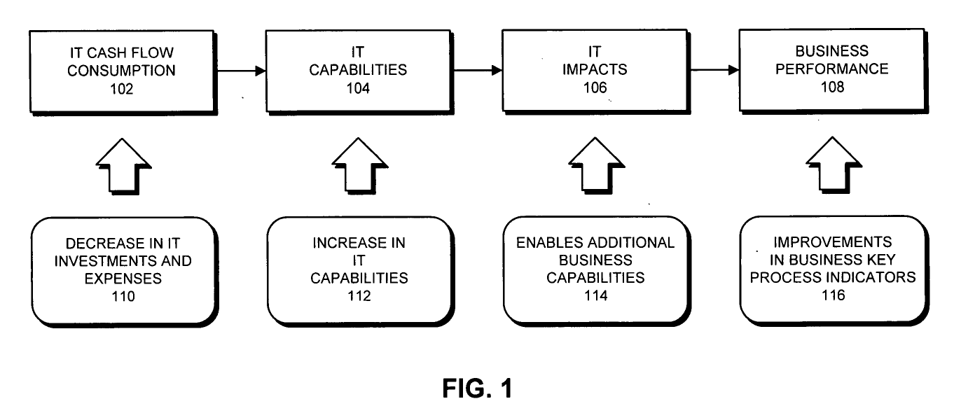

FIG. 1 illustrates benefits of electronic outsourcing of information technology in accordance with an embodiment of the present invention. The benefits of electronic outsourcing of information technology accrue in four major categories. These categories include information technology (IT) cash flow consumption 102, IT capabilities 104, IT impacts 106, and business performance 108.

IT cash flow consumption 102 benefits from the electronic outsourcing of information technology by a decrease in IT investments and expenses 110. This decrease is a result of factors that can include: a reduction in the number of IT personnel, a reduction in the amount of research related to IT solutions, and a reduction in customizing “off-the-shelf” solutions within the enterprise.

IT capabilities 104 benefit from the electronic outsourcing of information technology by an increase in IT capabilities 112. This increase in IT capabilities 112 follows from having a dedicated electronic outsourcing staff to research and implement the latest technology relating to the business. This is a result of the core business of the outsourcing staff being information technology.

IT impacts 106 benefit from the electronic outsourcing of information technology by enabling additional business capabilities 114. The outsourcing staff is constantly aware of the needs of the business and the availability of new capabilities to fulfill these needs. Hence, upgrades can be made to the information technology solution without distracting from the core capabilities of the business.

Business performance 108 benefits from the electronic outsourcing of information technology by improvements in business key process indicators 116. These improvements in business key process indicators 116 include reduced cash flow consumption for information technology solutions, in increase in information technology capabilities, and additional information technology capabilities.

Implementing an Electronic Outsourcing Solution

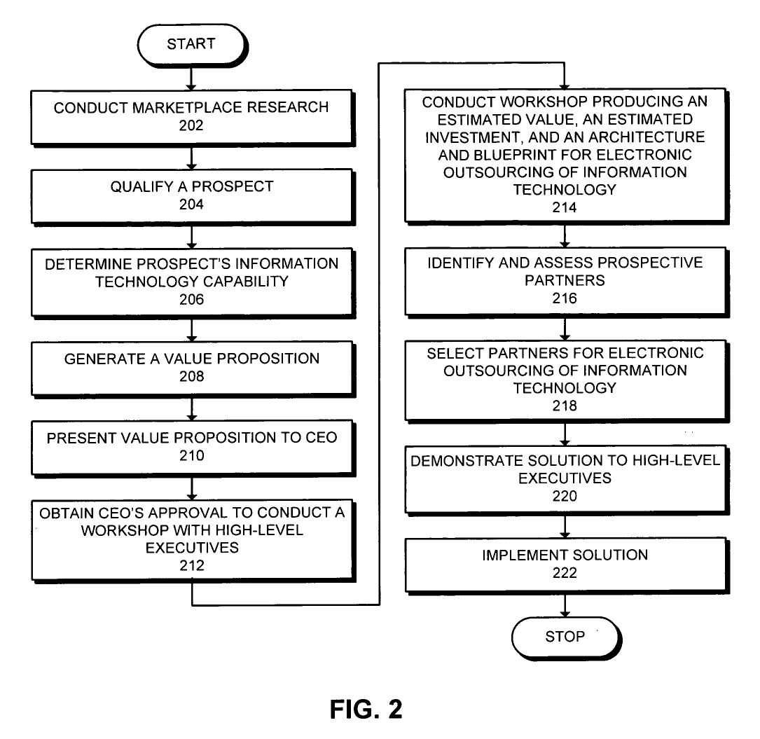

FIG. 2 presents a flowchart illustrating the process of implementing an electronic outsourcing solution to information technology in accordance with an embodiment of the present invention. The system starts by conducting a marketplace research to determine businesses that would benefit from electronic outsourcing of information technology solutions (step 202). These businesses typically include businesses that are leaders in their particular industry. Next, the system qualifies a prospect from among the businesses identified by the market research (step 204).

The system then determines the prospect's information technology capability and identifies the prospect's unmet needs (step 206). From the identified capabilities and needs, the system generates a value proposition (step 208). This value proposition includes cost and benefit comparisons between the current information technology solution and implementing an electronic outsourcing solution. This value proposition is presented to the Chief Executive Officer (CEO) of the selected business (step 210). Next, the CEO's approval is obtained to conduct a workshop with high-level executives of the enterprise (Step 212). These high-level executives can include, but are not limited to, the CEO, the Chief Operating Officer (COO), the Chief Financial Officer (CFO), the Chief Information Officer (CIO), and other officers designated by the CEO.

After obtaining the CEO's approval, the workshop is conducted with these high-level executives to produce an estimated value, an estimated investment, and an architecture and blueprint for electronic outsourcing of information technology (step 214).

Next, prospective partners for the electronic outsourcing of information technology are identified and assessed (step 216). Partners may be necessary for a variety of reasons including requirements of the target business and requirements of political entities. Validated partners are then selected for electronic outsourcing of the information technology solutions (step 218).

After creating an electronic outsourcing solution, including partners if necessary, the electronic outsourcing solution is demonstrated to the high-level executives of the business (step 220). Finally, after approval is received from the business, the electronic outsourcing solution is implemented (step 222).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for performing a value assessment of electronic outsourcing of information technology, comprising:
conducting marketplace research to determine an industry that would benefit from electronic outsourcing of information technology;
qualifying a prospect within the industry;
researching the industry and the prospect to determine a current information technology capability of the prospect;
generating a value proposition for a Chief Executive Officer (CEO) of the prospect, wherein the value proposition identifies benefits of electronic outsourcing of information technology;
presenting the value proposition to the CEO; and
obtaining the CEO's approval to conduct a workshop associated with electronic outsourcing of information technology to one or more highest-level executives of the prospect.

2. The method of claim 1, wherein the highest-level executives of the prospect can include the CEO, a Chief Operating Officer (COO), a Chief Financial Officer (CFO), a Chief Information Officer (CIO), and other officers designated by the CEO.

3. The method of claim 1, further comprising conducting the workshop to the one or more highest-level executives of the prospect, wherein conducting the workshop involves:
estimating a value of outsourcing the information technology capability;
estimating an investment required to implement outsourcing of the information technology capability; and
producing an architecture and blueprint for outsourcing the information technology capability as applied to the prospect.

4. The method of claim 1, further comprising identifying and assessing prospective partners for facilitating outsourcing of the information technology capability.

5. The method of claim 4, further comprising selecting partners, if necessary, for facilitating outsourcing of the information technology capability.

6. The method of claim 1, further comprising demonstrating outsourcing of the information technology capability to the one or more highest-level executives of the prospect and additional persons designated by the CEO.

7. The method of claim 6, further comprising implementing outsourcing of the information technology capability.

8. A means for performing a value assessment of electronic outsourcing of information technology, comprising:
a means for conducting marketplace research to determine an industry that would benefit from electronic outsourcing of information technology;
a means for qualifying a prospect within the industry;
researching the industry and the prospect to determine a current information technology capability of the prospect;
a means for generating a value proposition for a Chief Executive Officer (CEO) of the prospect, wherein the value proposition identifies benefits of electronic outsourcing of information technology;
a means for presenting the value proposition to the CEO; and
a means for obtaining the CEO's approval to conduct a workshop associated with electronic outsourcing of information technology to one or more highest-level executives of the prospect.

9. The means of claim 8, wherein the highest-level executives of the prospect can include the CEO, a Chief Operating Officer (COO), a Chief Financial Officer (CFO), a Chief Information Officer (CIO), and other officers designated by the CEO.

10. The means of claim 8, further comprising a means for conducting the workshop to the one or more highest-level executives of the prospect, wherein conducting the workshop involves:
estimating a value of outsourcing the information technology capability;
estimating an investment required to implement outsourcing of the information technology capability; and
producing an architecture and blueprint for outsourcing the information technology capability as applied to the prospect.

11. The means of claim 8, further comprising a means for identifying and assessing prospective partners for facilitating outsourcing of the information technology capability.

12. The means of claim 11, further comprising a means for selecting partners, if necessary, for facilitating outsourcing of the information technology.

13. The means of claim 8, further comprising a means for demonstrating outsourcing of the information technology capability to the one or more highest-level executives of the prospect and additional persons designated by the CEO.

14. The means of claim 13, further comprising a means for implementing outsourcing of the information technology capability.

15. A process for performing a value assessment of electronic outsourcing of information technology, comprising:
examining an opportunity to add value to a business through electronic outsourcing of information technology;
creating an electronic outsourcing solution of information technology to exploit the opportunity; and
implementing the electronic outsourcing solution.

16. The process of claim 15, wherein examining the potential to add value to a business through electronic outsourcing of information technology involves considering, current information technology level of the business, information technology trends and needs, competitors information technology levels, efficiencies, and financial health in view of electronic outsourcing information technology as a main driver of change.

17. The process of claim 15, wherein creating an electronic outsourcing solution of information technology to exploit the opportunity involves:
foreseeing a potential role for the business in the future; and
determining how to leverage a transformation that will improve the business by taking advantage of an electronic outsourcing solution of information technology to exploit the opportunity.

18. The process of claim 17, wherein determining how to leverage the transformation includes identifying and assessing potential partners to assist in exploiting the opportunity to add value to the business.

19. The process of claim 18, further comprising selecting partners, if necessary, to assist in realizing the potential to add value to the business.

20. The process of claim 19, further comprising implementing the electronic outsourcing solution of information technology within the business.
